(19) United States
(12) Patent Application Publication
(10) Pub. No.: US 2023/0011542 A1
(43) Pub. Date: Jan. 12, 2023

(54) METHOD FOR MANUFACTURING SYNTHETIC RESIN CONTAINER AND SYNTHETIC RESIN CONTAINER

(71) Applicant: TOYO SEIKAN CO., LTD., Tokyo (JP)

(72) Inventors: Hiromitsu KIYOTO, Yokohama-shi, Kanagawa (JP); Masashi FUJIOKA, Yokohama-shi, Kanagawa (JP); Soya YOSHIDA, Yokohama-shi, Kanagawa (JP); Yuuichi MIYAZAKI, Yokohama-shi, Kanagawa (JP); Youichi TADOKORO, Yokohama-shi, Kanagawa (JP)

(73) Assignee: TOYO SEIKAN CO., LTD., Tokyo (JP)

(21) Appl. No.: 17/785,288

(22) PCT Filed: Oct. 5, 2020
(86) PCT No.: PCT/JP2020/037712

§ 371 Date: Jun. 14, 2022

(30) Foreign Application Priority Data
Dec. 24, 2019 (JP) 2019-232626

(51) Int. Cl. B29C 49/22; B65D 1/02; B29C 49/48

(52) U.S. Cl. CPC B29C 49/22; B65D 1/0215; B65D 1/0246; B65D 1/0284; B29C 49/48; B29K 2667/003

(57) ABSTRACT

A synthetic resin container and method for manufacturing the same, including a container main body molded into a predetermined container shape and a covering layer laminated on an outer peripheral surface side of the container main body. The method includes heating the composite preform to bring the covering material layer into a molten state or a semi-molten state while softening the preform main body to be stretchable, subsequently molding the composite preform into a predetermined container shape by using a blow molding die in which an edge portion formed by providing a step on a cavity inner peripheral surface extends along a predetermined direction, and providing, in the covering material layer to be molded integrally with the preform main body, a thin portion molded by being brought into pressure contact with the edge portion.

### TECHNICAL FIELD

The present invention relates to a method for manufacturing a synthetic resin container and a synthetic resin container.

### BACKGROUND ART

In the related art, a synthetic resin container formed by forming a preform using a synthetic resin such as polyethylene terephthalate, and then molding this preform into a bottle shape by stretch blow molding or the like is known as a beverage container for containing various types of beverages.

In a case where the container of this type is to have a function such as light shielding, a means for changing a material for forming the container main body is conceivable. However, when considering the recyclability of the bottle, the requirements for the material are strict, and there is a limit in obtaining the required function by changing the material of the container main body.

Thus, in recent years, it has been considered to give the container various functions and characteristics by forming a multi-layer container in which an outer surface of the container main body is covered with a covering layer having a specific function and characteristic (Patent Document 1).

Such a container can be produced by blow molding a multi-layer composite preform, with the covering layer being separated and removed from the container main body similarly to a label attached to a body portion of a conventional bottle, so that the plastic container main body (PET bottle) can be recycled. For separating the covering layer from the container main body, it has been considered to form perforations or cuts on the covering layer (Patent Documents 2 and 3).

### CITATION LIST

### Patent Literature

Patent Document 1: JP 2015-128858 A

Patent Document 2: JP 2016-055524 A

Patent Document 3: JP 2018-043482 A

### SUMMARY OF INVENTION

### Technical Problem

However, in a case where the covering layer is perforated or cut after the composite preform is blow molded to manufacture the container, there is a concern that the container main body may also be scratched. Furthermore, in a case where the container is produced by blow molding after the covering layer is perforated or cut at the stage of the composite preform, since a stretch ratio in each portion of the container body portion varies depending on a final shape of the container, the perforations or the cuts provided in advance may be broken or the perforations or the cuts themselves may expand. Thus, it is not easy to perform molding so as to provide the intended perforations or cuts on the covering layer of the container.

The present invention has been made in consideration of such a point, and an object of the present invention is to provide a method for manufacturing a synthetic resin container and the synthetic resin container including a container main body molded into a predetermined container shape and a covering layer laminated on an outer peripheral surface side of the container main body, and allowing the covering layer to be easily separated from the container main body after use.

### Solution to Problem

A method for manufacturing a synthetic resin container according to the present invention is a method for manufacturing the synthetic resin container, the synthetic resin container being manufactured by blow molding a composite preform including a preform main body having a bottomed cylindrical shape and a covering material layer laminated on an outer peripheral surface side of the preform main body, the method including heating the composite preform to bring the covering material layer into a molten state or a semi-molten state while softening the preform main body to be stretchable, subsequently molding the composite preform into a predetermined container shape by using a blow molding die in which an edge portion formed by providing a step on a cavity inner peripheral surface extends along a predetermined direction, and providing, in the covering material layer to be molded integrally with the preform main body, a thin portion molded by being brought into pressure contact with the edge portion.

A synthetic resin container according to the present invention is a synthetic resin container including a container main body molded into a predetermined container shape and a covering layer laminated on an outer peripheral surface side of the container main body, and is configured such that a step portion extending along a predetermined direction is provided on the container main body and a thin portion formed along the step portion is provided on the covering layer.

A synthetic resin container according to the present invention is a synthetic resin container including a container main body molded into a predetermined container shape and a covering layer laminated on an outer peripheral surface side of the container main body, and is configured such that a groove-shaped recessed portion continuously or discontinuously extending along a predetermined direction is provided on the container main body and a thin portion formed along a groove bottom of the groove-shaped recessed portion is provided on the covering layer.

### Advantageous Effects of Invention

According to the present invention, it is possible to easily separate the container main body and the covering layer from each other by tearing the covering layer along the thin portion of the covering layer provided on the container body portion when disposing the container in which the content has been consumed.

### BRIEF DESCRIPTION OF DRAWINGS

FIG. 1 is a front view schematically illustrating a first embodiment of a synthetic resin container according to the present invention.

FIG. 2 is an end view taken along line A-A in FIG. 1.

FIG. 3 is an enlarged end view of a main part illustrating a range surrounded by a dashed line in FIG. 2 with respect to the first embodiment of the synthetic resin container according to the present invention.

FIG. 4 is an end view taken along line B-B in FIG. 1.

FIG. 5 is an enlarged end view of a main part illustrating a range surrounded by a dashed line in FIG. 4 with respect to the first embodiment of the synthetic resin container according to the present invention.

FIG. 6 is a vertical end view schematically illustrating a composite preform for manufacturing the synthetic resin container according to the present invention.

FIG. 7 is an end view schematically illustrating a blow molding die for manufacturing the first embodiment of the synthetic resin container according to the present invention.

FIG. 8 is an end view taken along line C-C in FIG. 7, and is an enlarged lateral end view of a main part of the blow molding die for manufacturing the first embodiment of the synthetic resin container according to the present invention.

FIG. 9 is an explanatory diagram illustrating a state in which the inner surface shape of the blow molding die provides a shape for the container in a blowing process of manufacturing the first embodiment of the synthetic resin container according to the present invention.

FIG. 10 is a lateral end view schematically illustrating a second embodiment of the synthetic resin container according to the present invention.

FIG. 11 is an enlarged lateral end view of a main part of a blow molding die for manufacturing the second embodiment of the synthetic resin container according to the present invention.

FIG. 12 is a front view schematically illustrating a third embodiment of the synthetic resin container according to the present invention.

FIG. 13 is an end view taken along line D-D in FIG. 12.

FIG. 14 is an enlarged end view of a main part illustrating a range surrounded by a dashed line in FIG. 13 with respect to the third embodiment of the synthetic resin container according to the present invention.

FIG. 15 is an enlarged lateral end view of a main part of a blow molding die for manufacturing the second embodiment of the synthetic resin container according to the present invention.

FIG. 16 is a front view schematically illustrating a modified example of the third embodiment of the synthetic resin container according to the present invention.

FIG. 17 is a perspective view schematically illustrating a fourth embodiment of the synthetic resin container according to the present invention.

### DESCRIPTION OF EMBODIMENTS

Preferred embodiments of the present invention will be described below with reference to the drawings.

### First Embodiment

A first embodiment of the present invention will be described.

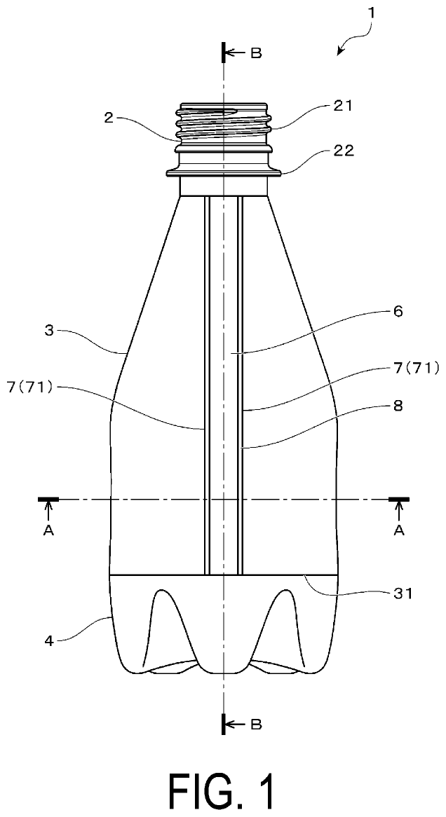

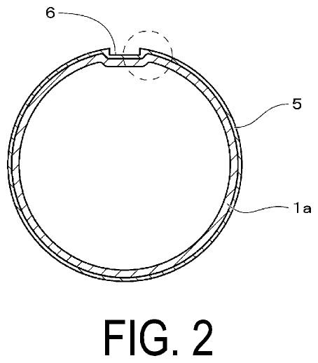

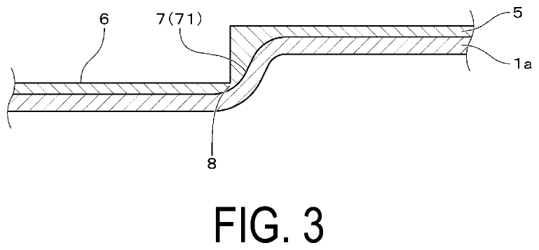

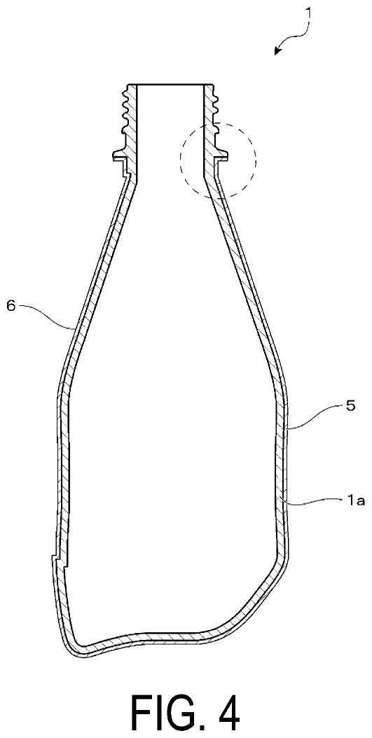

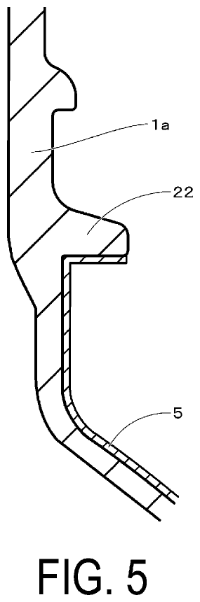

FIG. 1 is a front view schematically illustrating a synthetic resin container 1 according to the present embodiment, and FIG. 2 is an end view taken along line A-A in FIG. 1. Note that a range surrounded by a dashed line in FIG. 2 is enlarged and illustrated in FIG. 3. FIG. 4 is an end view taken along line B-B in FIG. 1, and FIG. 5 is an enlarged end view of a main part illustrating a range surrounded by a dashed line in FIG. 4.

In the present embodiment, the container 1 includes a mouth portion 2, a body portion 3, and a bottom portion 4, and also includes a container main body 1a molded into a predetermined container shape and a covering layer 5 laminated on the outer peripheral surface side of the container main body 1a. In the illustrated example, the body portion 3 of the container 1 is formed in a substantially cylindrical shape, and the bottom portion 4 includes a leg portion having a so-called petaloid shape.

The mouth portion 2 is a portion having a cylindrical shape serving as a spout for the content. A thread 21 for attaching a lid body (not illustrated) is provided on a side surface closer to an opening end side of the mouth portion 2. A neck ring 22 annularly protruding along the circumferential direction is provided closer to a lower end side of the mouth portion 2.

A band-shaped recessed portion 6 having a predetermined width and recessed in a concave shape inward to the container and extending along an axial direction is provided in the body portion 3 of the container main body 1a. Step portions 7 raised from a bottom surface of the band-shaped recessed portion 6 and connected to a circumferential surface of the body portion 3 are formed in both end edges 71 in a width direction of the band-shaped recessed portion 6.

On the other hand, on the covering layer 5 laminated on the outer peripheral surface side of the container main body 1 a, a thin portion 8 in which the covering layer 5 is relatively thin is provided in a linear shape along the step portions 7 of the both end edges 71 of the band-shaped recessed portion 6.

According to such a container 1, it is possible to easily separate the container main body 1a and the covering layer 5 from each other by tearing the covering layer 5 along the thin portion 8 provided in the linear shape when disposing the container 1 in which the content has been consumed.

Such a synthetic resin container 1 can be produced by blow molding a composite preform 10 including a preform main body 10a having a bottomed cylindrical shape with a mouth portion 20 on one open end side and a covering material layer 50 laminated on the outer peripheral surface side of the preform main body 10a by using a blow molding die 90 having a predetermined inner surface shape.

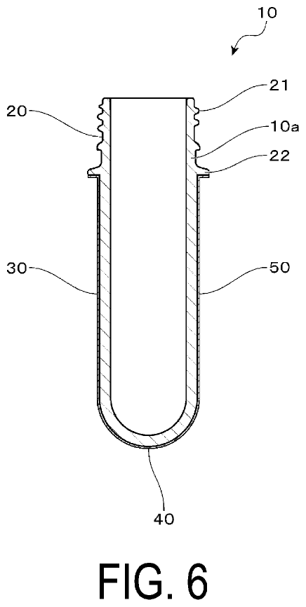

FIG. 6 is a vertical end view schematically illustrating a composite preform 10 for manufacturing the synthetic resin container according to the present invention, and the composite preform 10 illustrated in FIG. 6 includes the mouth portion 20, a body portion 30, and a bottom portion 40.

In the illustrated example, the covering material layer 50 included in the composite preform 10 covers a portion from immediately below the mouth portion 20 to the bottom portion 40, in other words, a portion stretched by blow molding, and is provided such that a distal end side of the covering material layer 50 reaches a peripheral end edge of the neck ring 22 while covering a lower surface of the neck ring 22 provided on the mouth portion 20 closer to the lower end side.

Here, in the present embodiment, up, down, left, right, vertical and horizontal directions of the container 1 are defined in a state illustrated in FIG. 1 in which the container 1 is erected with the mouth portion 2 facing up, and the up, down, left, right, vertical and horizontal directions of the composite preform 10 are similarly defined in a state illustrated in FIG. 6 with the mouth portion 20 facing up.

In blow molding the composite preform 10, the mouth portion 20 including the neck ring 22 is not stretched and becomes the mouth portion 2 of the container 1 as it is, and the distal end side the covering material layer 50 covering the lower surface of the neck ring 22 is also left as it is. As a result, in a case where the covering material layer 50 included in the composite preform 10 is provided as described above, the covering layer 5 included in the container 1 is similarly provided such that a distal end side of the covering layer 5 reaches the peripheral end edge of the neck ring 22 while covering the lower surface of the neck ring 22 provided closer to the lower end side of the mouth portion 2.

In a case where the covering layer 5 is provided so as to reach the peripheral end edge of the neck ring 22 in this way, the distal end of the covering layer 5 can be a starting point for separating the covering layer 5 from the container main body 1a by, for example, hooking a finger on the distal end of the covering layer 5 reaching the peripheral end edge of the neck ring 22, in separating the covering layer 5 from the container main body.

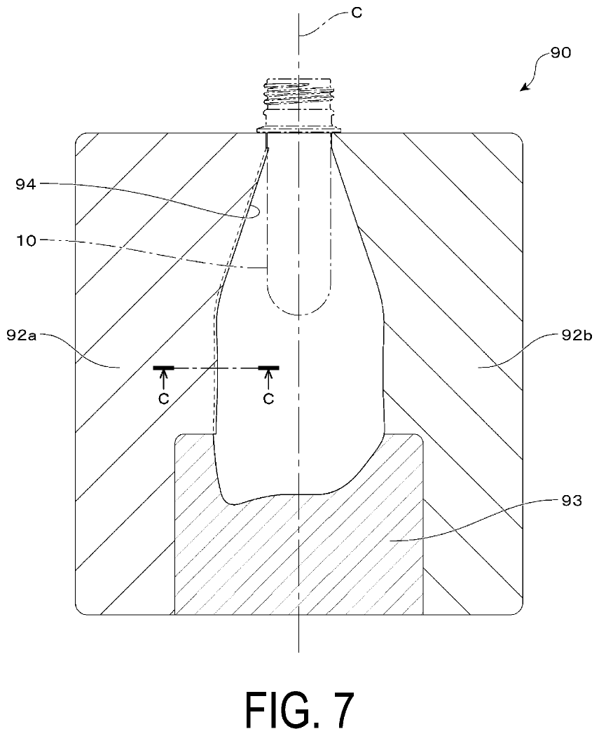

FIG. 7 is an end view schematically illustrating a blow molding die 90 for manufacturing the first embodiment of the synthetic resin container according to the present invention and illustrates the blow molding die 90 for blow molding the synthetic resin container 1 of an end surface corresponding to the end surface taken along line B-B in FIG. 4. Note that, the composite preform 10 set in the blow molding die 90 is illustrated by a dash-dotted line in FIG. 7.

The blow molding die 90 is for molding the composite preform 10 into the predetermined container shape by biaxial stretch blow molding and includes body molding dies 92a and 92b formed of a pair of split molding dies divided with a surface including a center line C of the container 1 serving as a parting surface and a base molding die 93 incorporated into the body molding dies 92a and 92b.

The blow molding die 90 is configured such that, when the blow molding die 90 is closed, a cavity corresponding to a container shape of the container 1 is formed in the molding die, the body portion 3 is shaped by the body molding dies 92a and 92b, and the bottom portion 4 is shaped by the base molding die 93.

On the cavity inner peripheral surface of the body molding die 92a of the blow molding die 90 used in the present embodiment, a protruding portion 94 for shaping the band-shaped recessed portion 6 on the container main body 1a of the container 1 is provided along an axial direction from an upper end to a lower end of the body molding die 92a so as to protrude with a predetermined width. Both end edges of the protruding portion 94 in the width direction are formed to provide steps on the cavity inner peripheral surface in such a manner that side surfaces 94b of the protruding portion 94 provided so as to rise steeply from the cavity inner peripheral surface toward the cavity inner side continues to an upper surface 94a of the protruding portion 94 at a predetermined height.

In the present embodiment, by providing such steps on both end edges of the protruding portion 94, edge portions 95 formed of the side surface 94b and the upper surface 94a of the protruding portion extend in two rows along the axial direction.

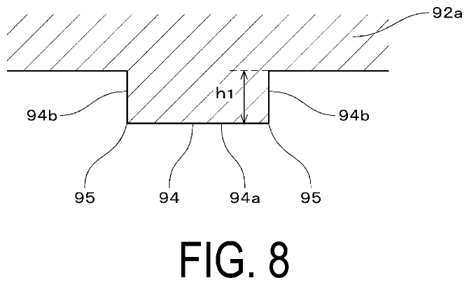

Note that FIG. 8 is an end view taken along C-C in FIG. 7 and is an enlarged lateral end view of a main part schematically illustrating a lateral end surface near the protruding portion 94 of the body molding die 92a used in the present embodiment.

In the present embodiment, as long as the blow molding is performed using the blow molding die 90 in which the edge portions 95 formed by providing the steps on the cavity inner peripheral surface are formed on both end edges of the protruding portion 94, by providing the protruding portion 94 having the predetermined width on the cavity inner peripheral surface along the predetermined direction, the other specific configuration of the blow molding die 90 is not particularly limited.

In order to mold the composite preform 10 into the predetermined container shape by using such a blow molding die 90, the composite preform 10 is heated in advance to be in a stretchable state. Then, a portion from immediately below the neck ring 22 to the bottom portion 40 housed in the blow molding die 90 is stretched by high-pressure fluid blowing in an axial direction and a circumferential direction while being stretched by a stretching rod in the axial direction as necessary. As a result, the cavity shape of the blow molding die 90 is transferred to the stretched portion, and thus the stretched portion is molded into the predetermined container shape.

At this time, the container main body 1a is formed by the stretched preform main body 10a, and the covering layer 5 covering the surface of the container main body 1a is formed by the covering material layer 50 covering the preform main body 10a.

In the present embodiment, in the case where the composite preform 10 is blow molded in this manner, the preform main body 10a is heated to a temperature equal to a melting point or less and equal to a glass-transition temperature or more of a resin material for forming the preform main body 10a to be in a softened state so as to be stretchable. On the other hand, the covering material layer 50 is heated to a temperature (for example, from (melting point −30)° C. to (melting point +30)° C.)) near the melting point of the resin material for forming the covering material layer 50, and is in a molten state or a semi-molten state with high fluidity.

In heating the composite preform 10, in order to heat each of the preform main body 10a and the covering material layer 50 as described above, for example, the composite preform 10 may be heated from the outside by an infrared heater or the like, and the composite preform 10 may be also heated from the inside by, for example, inserting a rod-shaped high-frequency induction heating element heated by high-frequency induction heating into the composite preform 10, thus appropriately adjusting the heating temperature from the inside and outside.

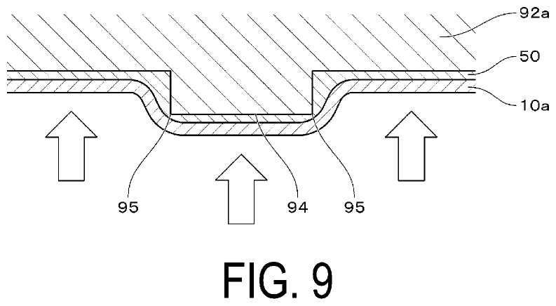

FIG. 9 is an explanatory diagram illustrating a state in which the inner surface shape of the body molding die 92a provides a shape for the container 1 by the body molding die 92a used in the present embodiment, and schematically illustrates a lateral end surface near the protruding portion 94 of the body molding die 92a.

When the composite preform 10 heated to the temperature equal to the melting point or less and equal to the glass-transition temperature or more of the thermoplastic resin for forming the preform main body 10a is subjected to the blow molding, the preform main body 10a appears to be stretched along a concave-convex shape formed on the cavity inner peripheral surface, but more particularly, it is stretched so as to draw a smooth curve with respect to the concave-convex shape via the covering material layer 50. At this time, in the vicinity of the edge portion 95 provided on the body molding die 92a, the preform main body 10a has a positional relationship with respect to the edge portion 95 in which a corner of the edge portion 95 protruding toward the preform main body 10a side is closest to the preform main body 10a. In this manner, the container main body 1a is molded into the container shape in which the step portions 7 are formed thereon by the edge portion 95 provided on the body molding die 92a.

On the other hand, the covering material layer 50 to be molded integrally with the preform main body 10a is in the molten state or the semi-molten state with high fluidity, and flows so as to fill a space between the preform main body 10a and the cavity inner peripheral surface to be shaped into the concave-convex shape formed on the cavity inner peripheral surface. Thus, in the vicinity of the edge portion 95 provided on the body molding die 92a, the covering material layer 50 is pressed against the edge portion 95 and flows as the preform main body 10a is stretched in the positional relationship as described above, and thus the thin portion 8 molded by relatively thinning the covering layer 5 is formed in the portion pressed against the edge portion 95.

In this way, the container 1 can be produced in which the band-shaped recessed portion 6 having a predetermined width and extending along the axial direction is provided on the container main body 1a, the step portions 7 are formed on both end edges 71 of the band-shaped recessed portion 6, and the thin portion 8 is provided in the linear shape along the step portions 7 on the covering layer 5 of the container 1.

Note that, in forming the thin portion 8 on the covering layer 5, the narrower and clearer the thin portion 8 is formed, the easier the covering layer 5 is torn along the thin portion 8. From the viewpoint described above, it is preferable to appropriately design a shape, dimensions, and the like of the protruding portion 94.

For example, a height difference hi of the step shape formed by the edge portion 95 of the body molding die 92a is preferably from 0.1 mm to 5 mm.

Note that as long as the thin portion 8 can be formed on the covering layer 5 as described above, the edge portion 95 formed along the both end edges of the protruding portion 94 may be rounded.

In the present embodiment, the container 1 is illustrated in which the thin portions 8 are formed in the linear shape from the upper end to the lower end of the body portion 3 in the axial direction of the container 1 and a width between the two thin portions 8 formed on the container 1 after the blow molding is substantially equal from a start end to a terminal end, but the present invention is not limited to such an aspect. The thin portion 8 may be provided so as to allow the covering layer 5 to be separable from the container main body 1 a, and may be provided in a spiral shape along the circumferential surface of the body portion 3 by appropriately designing the shape, dimensions, and the like of the protruding portion 94 shaping the band-shaped recessed portion 6, for example. The thin portion 8 need not be linear. The width between the two thin portions 8 may be extended so as to be wider from the start end toward the terminal end, and the width between the two thin portions 8 may be formed so that wide and narrow alternately appear. Such a thin portion 8 may be provided on at least a part of the body portion 3 so that the covering layer 5 is separable from the container main body 1a.

In consideration of recyclability, ethylene terephthalate-based thermoplastic polyester such as polyethylene terephthalate (glass-transition temperature: from 50° C. to 90° C. and melting temperature: from 200° C. to 275° C.) can be preferably used as the thermoplastic resin for forming the preform main body 10a.

From the viewpoint of separating the covering layer 5 from the container main body 1a, as the thermoplastic resin for forming the covering material layer 50, it is preferable to use thermoplastic resin incompatible with the thermoplastic resin for forming the preform main body 10a.

For example, in a case where the ethylene terephthalate-based thermoplastic polyester is used as the thermoplastic resin for forming the preform main body 10a, a polyolefin-based resin such as polypropylene (melting point: from 160° C. to 170° C.), polyethylene (melting point: from 80° C. to 140° C.), or the like can be used for the thermoplastic resin for forming the covering material layer 50 of the composite preform 10. The polyolefin-based resin is preferable, since the melting point of the polyolefin-based resin is generally lower than the melting point of the ethylene terephthalate-based thermoplastic polyester, and in the blow molding, the heating temperature is easy to be adjusted when the covering material layer 50 is brought into the molten state or the semi-molten state while heating the composite preform 10 to soften the preform main body 10a to be stretchable, but no such limitation is intended.

For example, in a case where a gas barrier property is imparted to the container 1, a resin having the gas barrier property such as ethylene-vinyl alcohol copolymer, polymethaxylyleneadipamide (MXD6), or the like can be used as the resin constituting the covering material layer 50.

Furthermore, a pigment, a colorant, or the like may be added to the thermoplastic resin for forming the covering layer 5, such that the covering material layer 50 is colored in a desired hue, and for example, a plurality of the pigments and colorants may be mixed to form a marble pattern, thus improving a decorative effect. Various additives can be added as necessary without being limited by the recyclability required for the container main body 1a.

As described above, according to the present embodiment, it is possible to easily separate the container main body 1a and the covering layer 5 from each other by tearing the covering layer 5 along the thin portion 8 provided in the linear shape.

In a case where the perforations or the cuts are made in the covering layer 5 using a CO₂ laser or the like after the molding of the container 1 in order to facilitate peeling off of the covering layer 5, the container main body 1a may be scratched, but according to the embodiment of the present invention, the container main body 1a is not scratched. In a case where the perforations or the cuts are made before the composite preform 10 is subjected to the blow molding, there is a concern that the perforations or the cuts may be broken or the perforations or the cuts themselves may expand by the stretching due to the blow molding, or the perforations or the cuts may be filled by heating the covering material layer 50 in the blow molding process, but according to the embodiments of the present invention, the thin portion 8 is formed at an intended portion, and the covering layer 5 is not broken.

### Second Embodiment

Next, a second embodiment of the present invention will be described.

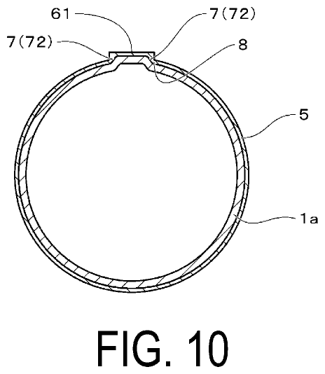

FIG. 10 is a lateral end view schematically illustrating a second embodiment of the synthetic resin container according to the present invention, and illustrates the end surface of the body portion 3 of the container 1 similarly to FIG. 2.

In the first embodiment described above, the container 1 is configured such that the band-shaped recessed portion 6 having the predetermined width and extending along the axial direction is provided on the container main body 1a, and the step portions 7 are formed on the both end edges 71 of the band-shaped recessed portion 6, and thus the thin portions 8 are provided along the step portions 7 on the covering layer 5.

In contrast, in the present embodiment, a container 1 is configured such that a band-shaped protruding portion 61 having a predetermined width and protruding in a convex shape from the body portion 3 of the container 1 and extending along the axial direction is provided on the container main body 1a, and the step portions 7 are formed on both end edges 72 of the band-shaped protruding portion 61, and thus the thin portion 8 is provided along the step portions 7 on the covering layer 5.

In the present embodiment, a body molding die processed in the similar manner as the body molding die 92a used in the first embodiment is used, except that, in production of the container 1 by blow molding the composite preform 10 as described above, instead of providing the protruding portion 94 on the body molding die 92a of the blow molding die 90, a groove-shaped portion 96 for shaping the band-shaped protruding portion 61 on the container main body 1a of the container 1 is provided to be recessed by a predetermined width from the upper end to the lower end of the body molding die 92a along the axial direction on the cavity inner peripheral surface of the body molding die 92a. The container 1 can be produced in the similar manner as in the first embodiment except for using such a body molding die.

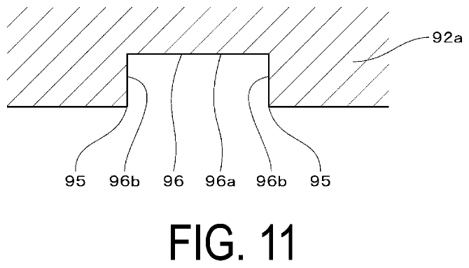

FIG. 11 is an end view corresponding to the end surface taken along C-C in FIG. 7 and is an enlarged lateral end view of a main part schematically illustrating a lateral end surface near the groove-shaped portion 96 of the body molding die 92a used in the present embodiment.

As illustrated in the drawings, both end edges of the groove-shaped portion 96 in the width direction are formed to provide steps on the cavity inner peripheral surface in such a manner that side surfaces 96b of the groove-shaped portion 96 provided so as to fall substantially vertically from the cavity inner peripheral surface toward the body molding die 92a inner side continues to a bottom surface 96a of the groove-shaped portion 96 at a predetermined height.

In the present embodiment, the blow molding die 90 is configured such that, by providing such steps on the both end edges of the groove-shaped portion 96, the edge portions 95 formed by the side surface 96b of the groove-shaped portion and the cavity inner peripheral surface extend in two rows along the axial direction, and thus the edge portions 95 formed by providing the steps on the cavity inner peripheral surface are formed.

In the present embodiment, by subjecting the composite preform 10 heated to the temperature described above to the blow molding by using such a blow molding die 90, the composite preform 10 is molded into the container shape in which the band-shaped protruding portion 61 having the predetermined width and extending along the axial direction is provided on the container main body 1a after the blow molding and the step portions 7 are formed in both end edges 72 of the band-shaped protruding portion 61. At the same time, the covering material layer 50 to be molded integrally with the preform main body 10a is pressed against the edge portions 95, and the thin portion 8 is provided in the linear shape along the step portions 7 on the covering layer 5, and thus the container 1 is produced.

Although the present embodiment differs from the first embodiment in the above-described respects, the other configurations are similar to those of the first embodiment, and thus redundant descriptions will be omitted.

### Third Embodiment

Next, a third embodiment of the present invention will be described.

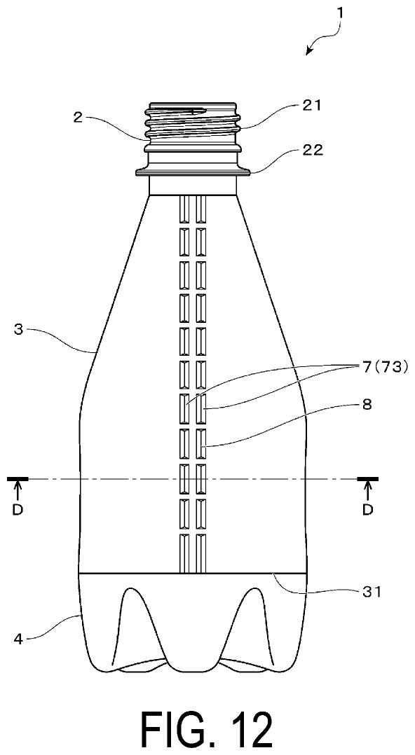

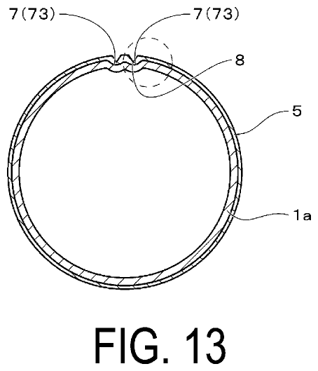

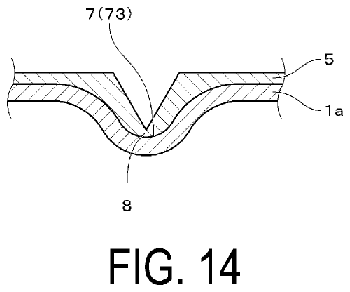

FIG. 12 is a front view schematically illustrating a synthetic resin container 1 according to the present embodiment, and FIG. 13 is an end view taken along line D-D in FIG. 12. Note that a range surrounded by a dashed line in FIG. 13 is enlarged and illustrated in FIG. 14.

In the first embodiment described above, the container 1 is configured such that the band-shaped recessed portion 6 having the predetermined width and extending along the axial direction is provided on the container main body 1a, and the step portions 7 are formed on the both end edges 71 of the band-shaped recessed portion 6, and thus the thin portions 8 are provided along the step portions 7 on the covering layer 5.

In contrast, in the present embodiment, a container 1 is configured such that two rows of a groove-shaped recessed portion 73 recessed in a substantially V-shape inward to the container and discontinuously extending along the axial direction are provided on the container main body 1a, and the thin portion 8 formed along a groove bottom of the groove-shaped recessed portion 73 is provided on the covering layer 5.

In the present embodiment, a body molding die 92a processed in the similar manner as the body molding die 92a used in the first embodiment is used, except that, in production of the container 1 by blow molding the composite preform 10 as described above, instead of providing the protruding portion 94 on the body molding die 92a of the blow molding die 90, two rows of a projecting portion 97 for shaping the groove-shaped recessed portion 73 on the container main body 1a of the container 1 are discontinuously provided projecting in a tapered shape toward a tip from the upper end to the lower end of the body molding die 92a along the axial direction on the cavity inner peripheral surface of the body molding die 92a. The container 1 can be produced in the similar manner as in the first embodiment except for using such a body molding die.

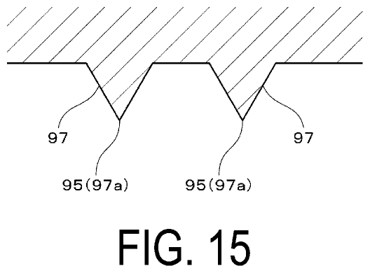

FIG. 15 is an end view corresponding to an end surface taken along C-C in FIG. 7 and is an enlarged lateral end view of a main part schematically illustrating a lateral end surface near the projecting portions 97 of the body molding die 92a used in the present invention.

As illustrated in the drawings, by providing the projecting portions 97 projecting in a tapered shape toward the tip, a height difference is formed from the cavity inner peripheral surface to the tip of the projecting portions 97, and thus the steps are provided on the cavity inner peripheral surface.

In the present embodiment, the blow molding die 90 is configured such that, by providing such steps on the projecting portion 97, the edge portions 95 each formed on an apex portion 97a of the projecting portion by the tip of the projecting portion and two side surfaces rising from the cavity inner peripheral surface toward the tip of the projecting portion 97 extend along the axial direction, and thus the edge portions 95 formed by providing the steps on the cavity inner peripheral surface are formed.

In the present embodiment, by subjecting the composite preform 10 heated to the temperature described above to the blow molding by using such a blow molding die 90, the composite preform 10 is molded into the container shape in which two rows of the groove-shaped recessed portion 73 recessed inward to the container with the groove bottom in the substantially V-shape and discontinuously extending along the axial direction are provided on the container main body 1 a after the blow molding. At the same time, the covering material layer 50 to be molded integrally with the preform main body 10a is pressed against the edge portions 95, and the thin portion 8 is provided in the discontinuous linear shape along the groove bottom of the groove-shaped recessed portion 73 on the covering layer 5, and thus the container 1 is produced.

According to the container 1 according to the present embodiment, it is possible to easily tear the covering layer 5 along the thin portion 8 discontinuously formed and having the perforation shape.

In forming the thin portion 8 on the covering layer 5, in order that the covering layer 5 can be easily torn along the thin portion 8, the shape and dimensions of the projecting portion 97, such as a height difference between the tip of the projecting portion 97 and the cavity inner peripheral surface and an angle of the edge portion 95 formed on the projecting portion 97, in other words, an angle between one side wall and another side wall with the tip of the projecting portion 97 as the center can be appropriately designed.

Note that as long as the thin portion 8 can be formed on the covering layer 5 as described above, the edge portion 95 formed at the apex portion of the projecting portion 97 may be rounded.

The groove-shaped recessed portion 73 discontinuously extending along the predetermined direction can be formed in the perforation shape provided with appropriate gaps by appropriately adjusting an interval within a range that does not impair hand cuttability of the covering layer 5 so that strength of the covering layer in the vicinity where the thin portion 8 is provided can be stabilized.

The groove-shaped recessed portion 73 may be configured so as to continuously extend along the predetermined direction, or may be continuously extended in the predetermined direction such that two types of groove portions (73a and 73b) having different groove depths are alternately provided.

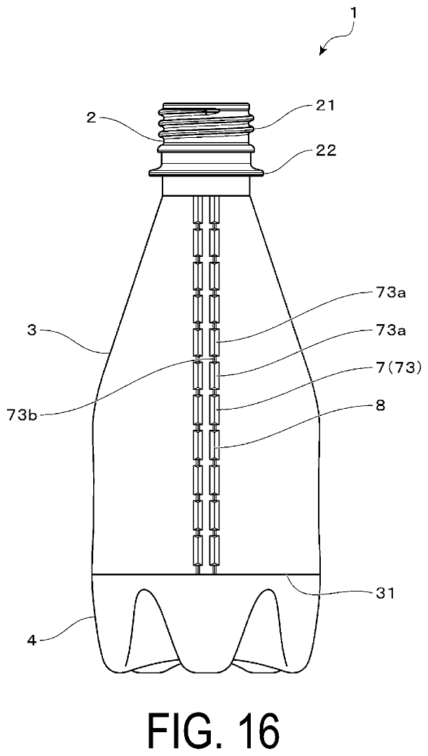

FIG. 16 is a front view schematically illustrating a synthetic resin container serving as a modified example of the present embodiment.

As illustrated in FIG. 16, another groove portion 73b having a smaller groove width than a groove width of the groove portion 73a and a shallow groove depth may be provided between the groove portions 73a to form the groove-shaped recessed portion 73 continuously extended. Such a container 1 can be formed by using the blow molding die 90 in which, with respect to the projecting portion 97 provided on the cavity inner peripheral surface of the body molding die 92a, the height to the tip of the projecting portion 97 and the width of the projecting portion 97 are appropriately designed to a desired shape. According to the shape of the projecting portion 97 provided on the body molding die 92a, it is also possible to alternately form the thin portions 8 having different thicknesses on the covering layer 5.

Although the present embodiment differs from the first embodiment in the above-described respects, the other configurations are similar to those of the first embodiment, and thus redundant descriptions will be omitted.

### Fourth Embodiment

Next, a fourth embodiment of the present invention will be described.

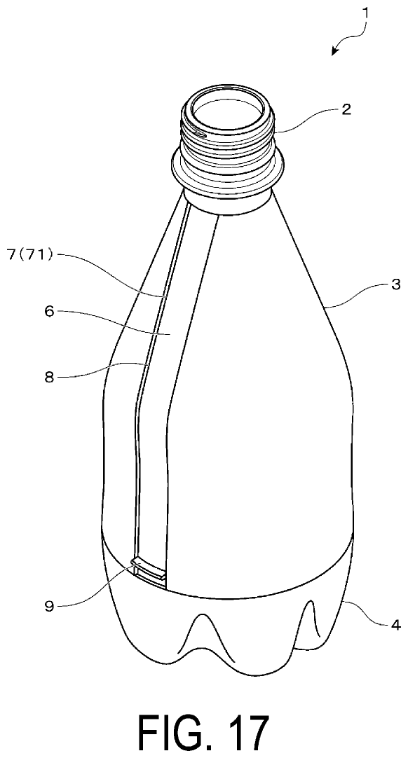

FIG. 17 is a perspective view schematically illustrating a fourth embodiment of the synthetic resin container 1 according to the present embodiment.

The present embodiment differs from the first embodiment described above in that a knob portion 9 molded with the covering layer 5 protruding outward from the container is provided closer to the lower end side of the band-shaped recessed portion 6 of the container 1.

In the present embodiment, in production of the container 1 by blow molding the composite preform 10 as described above, the blow molding die 90 is used, the blow molding die 90 being provided with a recessed clearance such that the covering material layer 50 having high flowability is inserted closer to the lower end side of the edge portion 95 of the cavity inner peripheral surface.

For example, the blow molding die 90 can be used in which a clearance portion is formed by the inner peripheral surface of the body molding die 92a being recessed closer to the lower end side of the band-shaped protruding portion 94. By using such a blow molding die 90, in blow molding, the covering material layer 50 heated and being in the flowable state enters into the clearance portion, and thus the knob portion 9 protruding outward from the container 1 is formed.

As a result, when the covering layer 5 is separated from the container 1, the knob portion 9 is pinched with fingers, and the covering layer 5 is torn along the thin portion 8 from the pinched side, and thus the container main body 1a and the covering layer 5 can be easily separated from each other.

Furthermore, when the molding die is clamped, by adjusting molding die clamping force in order that a slight clearance is secured on a parting surface between the body molding die 92a and the base molding die 93, a so-called burr may be intentionally formed on a parting line 31 between the body portion 3 and the bottom portion 4 to form the knob portion 9. In this case, a body molding die divided into three portions along the longitudinal direction of the container 1 may be used so as to provide a split molding die for forming the edge portion 95, and the knob portion 9 may be formed only in the vicinity of the thin portion 8 by adjusting the molding die clamping force of the split molding die for forming the edge portion 95.

Although the present embodiment differs from the first embodiment in the above-described respects, the other configurations are similar to those of the first embodiment, and thus redundant descriptions will be omitted.

As described above, according to the present embodiment, the container 1 includes the covering layer 5 covering a portion excluding a part closer to the mouth portion 2 side. In disposing the container 1 in which the content has been consumed, the covering layer 5 can be easily peeled off from the container main body 1a along the thin portion 8 provided in the body portion 3, and thus the container main body 1a and the covering layer 5 can be easily separated from each other.

Although the present invention has been described with reference to the preferred embodiments, the present invention is not limited only to the embodiments described above, and various changes can be made within the scope of the present invention.

For example, the covering layer 5 on the lower surface of the neck ring 22 may be cut, or a cut-out portion for exposing the covering layer 5 covering the lower surface of the neck ring 22 may be provided closer to the peripheral end edge side of the neck ring 22 to allow a distal end side of the covering layer 5 to be easily pinched by fingers and the covering layer 5 may be torn along the thin portion 8 provided on the container body portion 3 from the pinched side.

The detailed configurations described in the above-described embodiments may be appropriately selected and combined.

In short, a synthetic resin container according to the present invention is a synthetic resin container 1 including a container main body 1a molded into a predetermined container shape and a covering layer 5 laminated on an outer peripheral surface side of the container main body 1a, and as long as a step portion 7 extending along a predetermined direction is provided on the container main body 1a and a thin portion 8 formed along the step portion 7 is provided on the covering layer 5, other detailed configurations can be changed as appropriate without being limited to the above-described embodiments.

A method for manufacturing a synthetic resin container according to the present invention is a method for manufacturing the synthetic resin container by blow molding a composite preform 10 including a preform main body 10a having a bottomed cylindrical shape and a covering material layer 50 laminated on an outer peripheral surface side of the preform main body 10a, and as long as the method includes heating the composite preform 10 to bring the covering material layer 50 into a molten state or a semi-molten state while softening the preform main body 10a to be stretchable, subsequently molding the composite preform 10 into a predetermined container shape by using a blow molding die 90 in which an edge portion 95 formed by providing a step on a cavity inner peripheral surface extends along a predetermined direction, and providing a thin portion 8 molded by being brought into pressure contact with the edge portion 95 on the covering material layer 50 to be molded integrally with the preform main body 10a, other detailed configurations can be changed as appropriate without being limited to the above-described embodiments.

### REFERENCE SIGNS LIST

1 Synthetic resin container
1a Container main body
2 Mouth portion
21 Thread
22 Neck ring
3 Body portion
4 Bottom portion
5 Covering layer
6 Band-shaped recessed portion
7 Step portion
8 Thin portion
9 Knob portion
10 Composite preform
10a Preform main body
20 Mouth portion
30 Body portion
40 Bottom portion
50 Covering material layer

1. A method for manufacturing a synthetic resin container, the synthetic resin container being manufactured by blow molding a composite preform including a preform main body having a bottomed cylindrical shape and a covering material layer laminated on an outer peripheral surface side of the preform main body, the method comprising:
heating the composite preform to bring the covering material layer into a molten state or a semi-molten state while softening the preform main body to be stretchable;
subsequently molding the composite preform into a predetermined container shape by using a blow molding die in which an edge portion formed by providing a step on a cavity inner peripheral surface extends along a predetermined direction; and
providing, in the covering material layer to be molded integrally with the preform main body, a thin portion molded by being brought into pressure contact with the edge portion.

2. The method for manufacturing the synthetic resin container according to claim 1, wherein a protruding portion having a predetermined width is provided along a predetermined direction on the cavity inner peripheral surface of the blow molding die whereby the edge portion is formed on both end edges of the protruding portion.

3. The method for manufacturing the synthetic resin container according to claim 1, wherein a groove-shaped portion having a predetermined width is provided along a predetermined direction on the cavity inner peripheral surface of the blow molding die whereby the edge portion is formed on both end edges of the groove-shaped portion.

4. The method for manufacturing the synthetic resin container according to claim 1, wherein a projecting portion having a shape tapering toward a tip is continuously or discontinuously provided along a predetermined direction on the cavity inner peripheral surface of the blow molding die whereby the edge portion is formed on an apex portion of the projecting portion.

5. The method for manufacturing the synthetic resin container according to claim 1, wherein
a polyethylene terephthalate-based resin is used as a resin material for forming the preform main body, and
a polyolefin-based resin is used as a resin material for forming the covering material layer.

6. A synthetic resin container comprising:
a container main body molded into a predetermined container shape; and
a covering layer laminated on an outer peripheral surface side of the container main body, wherein
a step portion extending along a predetermined direction is provided on the container main body, and
a thin portion formed along the step portion is provided on the covering layer.

7. The synthetic resin container according to claim 6, wherein
a band-shaped recessed portion having a predetermined width and extending along a predetermined direction is provided on the container main body, and
the step portion is formed on both end edges of the band-shaped recessed portion.

8. The synthetic resin container according to claim 6, wherein
a band-shaped protruding portion having a predetermined width and extending along a predetermined direction is provided on the container main body, and
the step portion is formed on both end edges of the band-shaped protruding portion.

9. A synthetic resin container comprising:
a container main body molded into a predetermined container shape; and
a covering layer laminated on an outer peripheral surface side of the container main body, wherein
a groove-shaped recessed portion continuously or discontinuously extending along a predetermined direction is provided on the container main body, and
a thin portion formed along a groove bottom of the groove-shaped recessed portion is provided on the covering layer.
